(19) United States
(12) Patent Application Publication
(10) Pub. No.: US 2026/0024252 A1
(43) Pub. Date: Jan. 22, 2026

(54) Artificial Intelligence Manipulation of Spoken Language

(71) Applicant: Comcast Cable Communications, LLC, Philadelphia, PA (US)

(72) Inventor: Richard Grzeczkowski, Philadelphia, PA (US)

(21) Appl. No.: 18/779,930

(22) Filed: Jul. 22, 2024

(51) Int. Cl. G06T 11/60; G06F 40/40

(52) U.S. Cl. CPC G06T 11/60; G06F 40/40; G06T 2211/441

(57) ABSTRACT

A video asset may comprise at least one dialog in a source language. A device may receive a request to translate the at least one dialog to a target language. The device may match the target language with facial data associated with the video asset.

### BACKGROUND

A video may include dialogs from a native language. Non-native language speaker may need the dialogs of the video translated to a corresponding language.

### SUMMARY

The following summary presents a simplified summary of certain features. The summary is not an extensive overview and is not intended to identify key or critical elements.

Systems, apparatuses, and methods are described for changing underlying spoken language of a video asset. A process engine may translate one or more dialogs associated with a native language to a target language, and alter the facial image of an actor in the video asset to give the visual appearance of the actor speaking the target language instead of the native language. The changing underlying spoken language with matching facial data enhance user experience as if the target language is spoken by the actor.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2A and FIG. 2B show hardware elements of a computing device.

FIG. 3 shows an example of changing underlying spoken language of a video asset.

FIG. 4 shows an example of selecting and obtaining video asset.

FIG. 5 shows an example of replacing a language and substituting one or more actors.

FIG. 6 shows an example of replacing one or more adverting products.

FIG. 7 shows an example of modifying context.

FIG. 8 is a table showing an example of manifest file.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

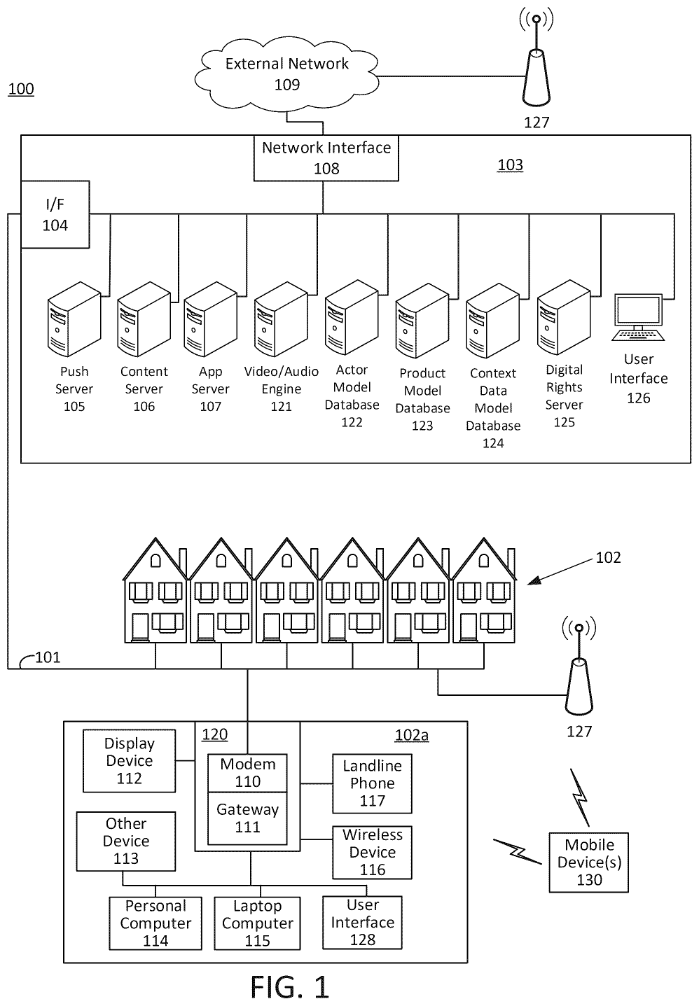

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 130 via one or more wireless networks. The mobile devices 130 may comprise smart phones, tablets, laptop computers, smart TVs or virtual reality (VR) devices with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as push server 105, content server 106, application server 107, video/audio engine 121, actor model database 122, product model database 123, trigger data model database 124, digital rights server 125 and/or user interface 126 to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 130 via the interface 108 and one or more of the external networks 109, e.g., via one or more of the wireless access points 127.

The push notification server 105 may be configured to generate push notifications to deliver information to devices in the premises 102 and/or to the mobile devices 130. The content server 106 may be configured to provide content to devices in the premises 102 and/or to the mobile devices 130. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 130. The local office 103 may comprise additional servers and devices, such as video/audio engine 121, actor model database 122, product model database 123, trigger data model database 124, digital rights server 125, user interface 126, additional push, content, and/or application servers, and/or other types of servers. The video/audio engine 121 may be configured to change underlying spoken language of a video. The actor model database 122 may be configured to store and provide machine learning models of associated actors and actresses (hereafter “actors”). The machine learning models of the associated actors may comprise speech model(s) and/or facial image model(s). The product model database 123 may be configured to store and provide product image model(s) of associated advertising products. The trigger data model database 124 may be configured to store and provide machine learning models of associated trigger data. The digital rights server 125 may be configured to validate the rights of voice/facial-expression/object/background modification. The user interface 126 may be configured to communicate a status of the video/audio engine 121. Although shown separately, the push server 105, the content server 106, the application server 107, video/audio engine 121, actor model database 122, product model database 123, trigger data model database 124, digital rights server 125, user interface 126 and/or other server(s) may be combined. The servers 105-107, video/audio engine 121, actor model database 122, product model database 123, trigger data model database 124, digital rights server 125, user interface 126, and/or other servers may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions or smart TVs), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA), virtual reality (VR) devices), landline phones 117 (e.g., Voice over Internet Protocol-VOIP phones), user interface 128, and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 130, which may be on- or off-premises.

The mobile devices 130, one or more of the devices in the premises 102a, and/or other devices may receive, store, output, and/or otherwise use assets. An asset may comprise a video, a game, one or more images, software, audio, text, webpage(s), and/or other content.

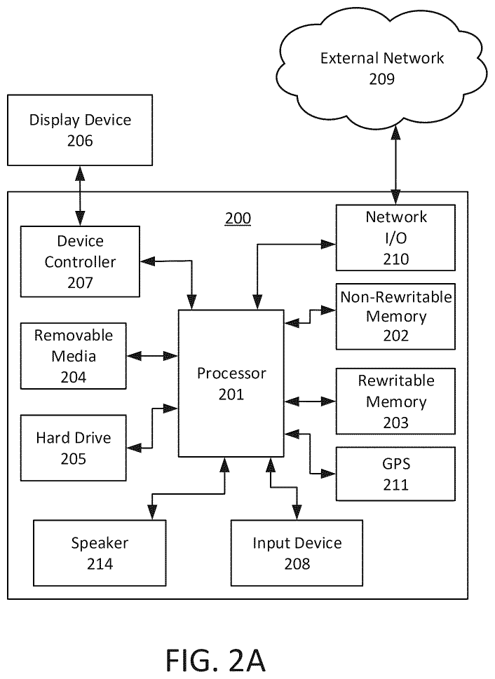

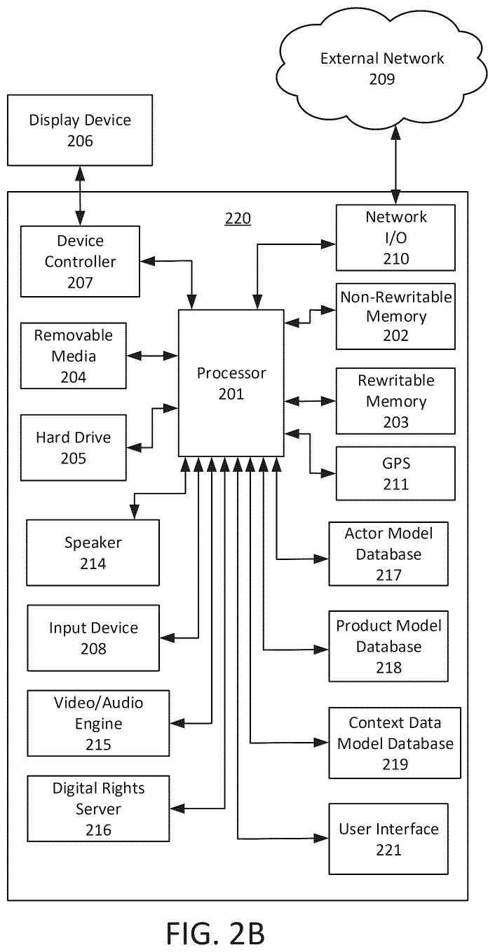

FIG. 2A shows hardware elements of a computing device 200 that may be used to implement any of the computing devices shown in FIG. 1 (e.g., the mobile devices 130, any of the devices shown in the premises 102a, any of the devices shown in the local office 103, any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, camera, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

FIG. 2B shows hardware elements of a computing device 220, which is similar to the computer device 200 with the addition of one or more of the following: video/audio engine 215, actor model database 217, product model database 218, trigger data model database 219, digital rights server 216 and user interface 221. The computing device 220, similar to the computing device 200, may be used to implement any of the computing devices shown in FIG. 1 (e.g., the mobile devices 130, any of the devices shown in the premises 102a, any of the devices shown in the local office 103, any of the wireless access points 127, any devices with the external network 109) and any other computing devices discussed herein. The video/audio engine 215 may be software executed by the processor 201, and may be configured to change underlying spoken language of a video. The actor model database 217 may be software executed by the processor 201, and may be configured to provide machine learning models of associated actors and actresses (hereafter “actors”). The machine learning models of the associated actors may comprise speech model(s) and/or facial image model(s). The product model database 218 may be software executed by the processor 201, and may be configured to provide product image model(s) of associated advertising products. The product model database 219 may be software executed by the processor 201, and may be configured to provide machine learning models of associated trigger data. The digital rights server 216 may be software executed by the processor 201, and may be configured to validate the rights of voice/facial-expression/object/background modification. The user interface 221 may be software executed by the processor 201, and may be configured to receive an input and communicate a status of the video/audio engine.

Although FIG. 2A and FIG. 2B show example hardware configurations, one or more of the elements of the computing device 200 or 220 may be implemented as software or a combination of hardware and software. Modifications may be made to add, remove, combine, divide, etc. components of the computing device 200 or 220. Additionally, the elements shown in FIG. 2A and FIG. 2B may be implemented using basic computing devices and components that have been configured to perform operations such as are described herein. For example, a memory of the computing device 200 or 220 may store computer-executable instructions that, when executed by the processor 201 and/or one or more other processors of the computing device 200 or 220, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

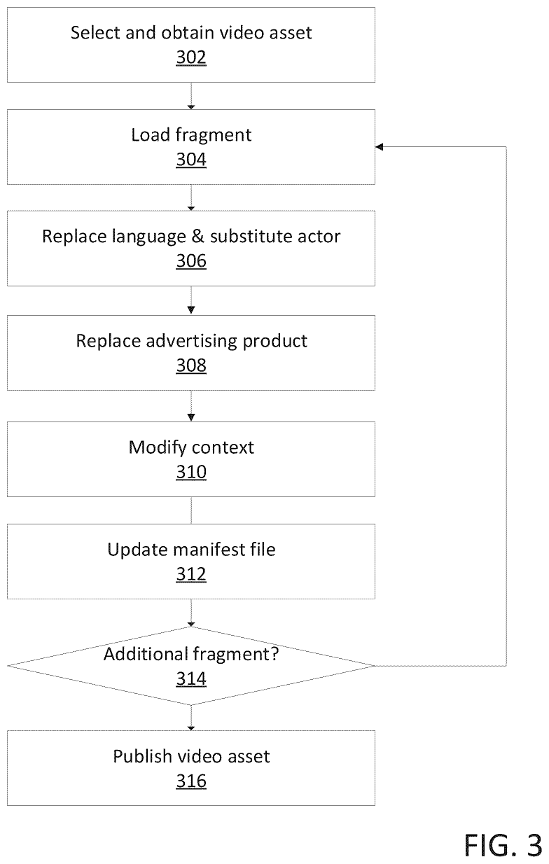

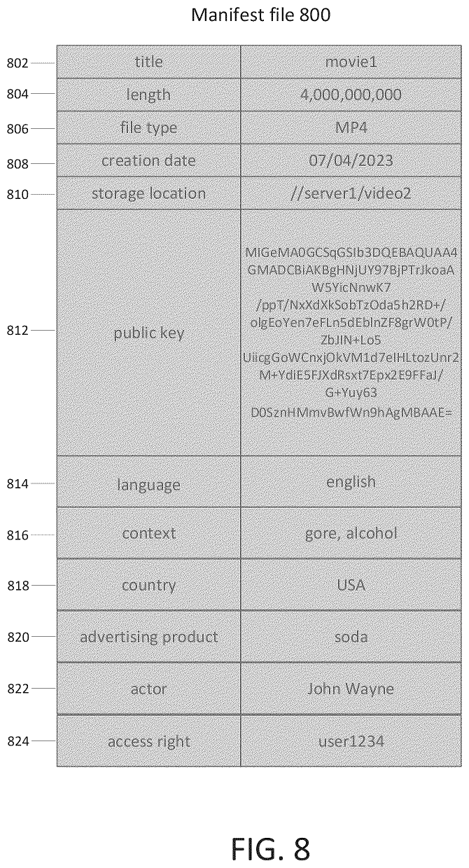

FIG. 3 is a flowchart showing an example of changing underlying spoken language of a video asset, according to embodiments of the disclosure. According to various embodiments, the example may be implemented by the system 100 shown in FIG. 1. The steps in FIG. 3 may be performed by any of the devices described herein, such as video/audio engine 121 as shown in FIG. 1 or video/audio engine 215 as shown in FIG. 2B. At 302, a video/audio engine (e.g., video/audio engine 121/215) may select and obtain video assets. The video assets may be stored in the content server 106. The video assets may be any type of video and/or audiovisual content, including movies, episodes of TV series, cutscenes of video games, touring videos in a theme park, etc. The video assets may comprise video and/or audio, and may further comprise manifest file as shown in FIG. 8. A user may instruct, via a user interface (e.g., user interface 126, 128 as shown in FIG. 1, user interface 221 as shown in FIG. 2B or user interface in mobile devices 130), the video/audio engine 121/215 to select and obtain one of the video assets. The user may be an administrator associated with the content owner. The administrator may modify the language, actors, advertising products and context associated with the video asset before the video asset is released to the public in a particular market. The dialogs in the video asset may comprise audio in a native language (e.g., Korean), which may be translated to a target language (e.g., English), and images of facial expressions of actors may be altered in the video asset to match the target language (e.g., as if the actors are speaking the target language). Throughout this disclosure, the “dialog” may be referred to as “speech”. The translation and visual synchronization may better convey the messages and enhance the experience to the non-native language users. There will be no additional processing delay to the non-native language users because the video assets are pre-processed.

The user may be a consumer. The video asset may be provided to the consumer in a freemium model. The video asset with the native language may be provided free to the consumer. The consumer may pay a fee or subscribe a paid membership to modify the video asset on demand (e.g., translating the native language to the target language, removing advertising products and/or modifying context).

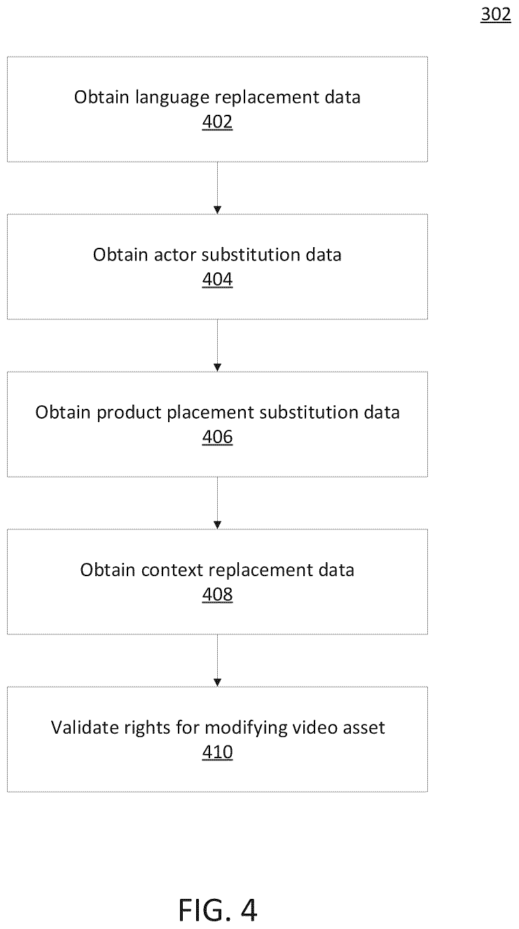

FIG. 4 is a flowchart showing an example of step 302. The steps in FIG. 4 may be performed by any of the devices described herein, such as video/audio engine 121 as shown in FIG. 1 or video/audio engine 215 as shown in FIG. 2B. At 402, a video/audio engine (e.g., video/audio engine 121/215) may obtain language replacement data from an input of a user interface (e.g., user interface 126, 128 as shown in FIG. 1, user interface 221 as shown in FIG. 2B, user interface in mobile devices 130, etc.), indicating desired changes to be made in a translation. The user interface may be used by a user to request various changes in a translation. For example, a user may provide an input requesting that a particular movie be translated from English to Chinese. The language replacement data may indicate a native language and a target language. Note that the native language and target language need not be completely different languages (e.g., Chinese and English), but rather may simply be different accents or dialects of a common language (e.g., English with a Southern accent and English with a Boston accent). The target language may be set to a default target language based on the Internet Protocol (IP) address of the user. For example, the target language associated with the user with US-based IP address may be set to English.

At 404, the video/audio engine 121/215 may obtain actor substitution data from the input of the user interface. The actor substitution data may indicate features associated with original actors (e.g., name, gender, hair color, eye color, country, race, gender) and features associated with replacement actors (e.g., name, gender, hair color, eye color, country, race, gender). As will be explained below, the translation of a video asset from a native language to a target language may include altering the video images of the video asset, to change the actor's appearance so that it appears that the actor is speaking the target language. This may involve changes to the shapes of the actor's mouth, eye expression, facial position, etc. This may even involve changing the actor's hair color, eye color, racial appearance, gender, to better match the appearance of someone speaking the target language. The actor substitution data may indicate changes to an actor's appearance, to correspond with translations of the audio and/or textual dialog spoken by the actor.

At 406, the video/audio engine 121/215 may obtain product placement substitution data from the input of the user interface. The product placement substitution data may indicate features associated with original advertising products (e.g., name, color, size, shape, type, country) and features associated with replacement advertising products (e.g., name, color, size, shape, type, country). The product placement substitution data may be used to alter the visual appearance of an object in a video asset, or to replace one object with another.

At 408, the video/audio engine 121/215 may obtain context replacement data from the input of the user interface. The context replacement data may comprise context and country. The context may comprise components of the video fragment, such as mature themes, language, depictions of violence, nudity, sensuality, depictions of sexual activity, adult activities, drug use, and/or background.

At 410, the video/audio engine 121/215 may validate rights for modifying the video asset. The video/audio engine 121/215 may send, to the digital right server 125, a request message of validate rights (e.g., license agreement(s)) for modifying the video asset. The request message may indicate requests to modify the language, the actor, the product replacement and/or the context associated with the video asset. The video/audio engine 121/215 may receive, from the digital right server 125, an acknowledgement associated with the request message. The acknowledgement may indicate validation results for allowing or denying the modifications of the language, the actor, the product replacement and/or the context. The video/audio engine 121/215 may proceed to step 304 if the validation result allows the video/audio engine 121/215 modifying the video asset. Otherwise, the method may stop and notify the user about the validation results via the user interface.

At 304, the video/audio engine 121/215 may load a fragment from the obtained video asset. The fragment may comprise a portion of the video asset. Each fragment may comprise a pre-determined portion with a fixed period. For example, a fragment may comprise a two-minute portion of a sixty-minute video asset, and there may be thirty portions. Fragments may be divided by scenes and each fragment may comprise a variable period. For example, one fragment with a first scene may be three minutes long, and another fragment with a second scene may be five minutes long. Dividing the video asset by scenes may make the video transition smoother from one scene to another scene, and may change the underlying spoken language more efficiently and accurately. An entire dialog of an actor may be intact if the video asset is divided by scenes. The video/audio engine 121/215 may initially load a first portion, and may subsequently load a second portion.

The video/audio engine 121/215 may decompose the loaded fragment into one or more images frames and audio frames. The one or more image frames may be an image sequence associated with the fragment. The number of decomposed frames may depend on the size of the fragment and the frame rate (frame per second). The one or more images frames and audio frames may be used in step 306, 308, 310 and 312.

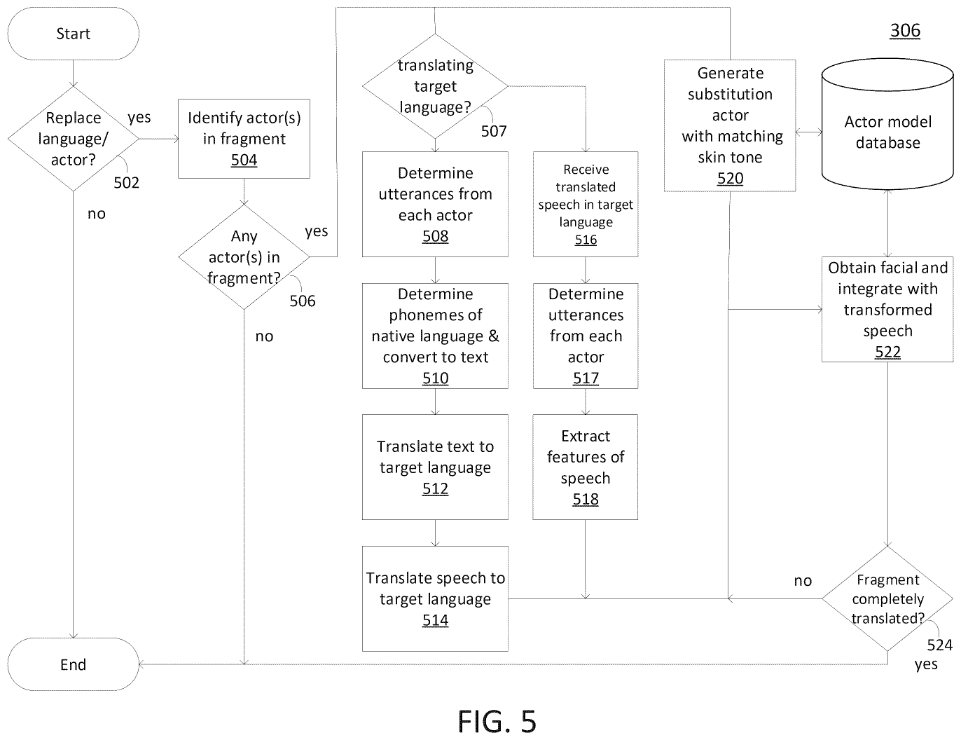

At 306, the video/audio engine 121/215 may replace a language and/or substitute an actor from the loaded fragment. FIG. 5 is a flowchart showing an example of step 306. The steps in FIG. 5 may be performed by any of the devices described herein, such as the video/audio engine 121/215.

At 502, the video/audio engine 121/215 may determine, based on the language replacement data (obtained in step 402) and the actor substitution data (obtained in step 404), whether language replacement and/or actor substitution have been requested (e.g., by the user input). A determination step may occur at 504 if language replacement and/or actor substitution are requested. The step 306 may end if there is no requested language replacement or actor substitution.

At 504, the video/audio engine 121/215 may identify one or more actors in the fragment. The video/audio engine 121/215 may use the one or more images frames and audio frames decomposed from step 304. For each image frame, the video/audio engine 121/215 may identify a position of each original actor. The video/audio engine 121/215 may generate region proposals (e.g., candidate bounding boxes) associated with the one or more actors, where the region proposals may contain the edges of the one or more actors. The video/audio engine 121/215 may further extract features from each region proposal using a deep convolutional neural network. The features may include age, height, gender, color, texture, size, and so on. Relevant features may have a correlation associated to the facial image model. The video/audio engine 121/215 may, based on the facial image model, classify features as one of the known class, wherein the correlation may exceed a threshold. The facial image model may be accessed from the actor model database (e.g., actor model database 122/217). The known class may be an object or a particular actor (e.g., the original actor to be substituted). The video/audio engine 121/215 may determine, based on the classified features associated with the region proposal, the position of the actor. The position may be pixel indices and/or spatial coordinates (e.g., cartesian coordinates). The video/audio engine 121/215 may classify multiple actors and positions of the corresponding actors. The positions of the actors may be classified corresponding timestamps.

The video/audio engine 121/215 at 506 may determine whether at least one actor appears in the one or more frames. Step 306 may end if there is no actor appearing in the one or more image frames. The video/audio engine 121/215 may proceed to 508 if language replacement is requested. The video/audio engine 121/215 may proceed to 520 if actor replacement is requested. Steps 507 and 520 may be conducted in parallel as shown in FIG. 5. Steps 507 and 520 may be conducted in series. For example, step 508 may be conducted before step 520, and vice versa.

At 507, the method may determine whether the target language is translated at the video/audio engine 121/215. The method may proceed to step 508 if the target language is translated at the video/audio engine 121/215. The method may proceed to step 508 if the target language is not translated at the video/audio engine 121/215.

At 508, the video/audio engine 121/215 may determine utterances from each actor, where the determined utterances may be associated with the timestamps. Table 1 may show four turns of timestamped speech. Actor 1 at T1 may initiate the speech by speaking first (“How may I help you?”), then Actor 2 at T2 may reply (“I want to go to New York.”), then Actor 1 at T3 may say (“New York?”) and finally Actor 4 at T4 may say (“Yes.”). The video/audio engine 121/215 may determine utterances from each actor and use an end of utterance to detect the turns of speech. The video/audio engine 121/215 may recognize the actor associated with each turn of speech. Identifying which actor is speaking may be conducted through the speech model, where the speech model may be accessed from the actor model database. Identifying which actor is speaking may also be conducted through determining the facial movement (e.g., lip or mouth movement) of a particular actor.

TABLE 1

| Time | Actor 1 | Actor 2 |
|---|---|---|
| T1 | How many I help you? | |
| T2 | | I want to go to New York. |
| T3 | New York? | |
| T4 | | Yes. |

At 510, the video/audio engine 121/215 may determine the phonemes of native language associated with each turn of speech and convert the speech to text. Each phoneme is a basic unit of speech. The video/audio engine 121/215 may convert sounds of the speech into a sequence of phonemes. The video/audio engine 121/215 may, based on the phonemes, detect text by using a language model. For example, a sequence of phonemes may comprise /t/, /a/, /bl/ and the video/audio engine 121/215 may detect this sequence as the word “table”. Using phonemes may improve the accuracy of speech-to-text. Utterances and phonemes are some examples of the features associated with the speech. Other features (e.g., tone, cadence, Mel-Frequency Cepstral Coefficients (MFCC), spectral contrast) of speech may be extracted by the video/audio engine 121/215.

At 512, the video/audio engine 121/215 may translate the detected text of a native language to a target language. The detected text may comprise a sequence of text associated with the turns of speech. The native and target language may be English, Spanish, French, Italian, German, Japanese, Chinese, etc. The translated text may be used as subtitles for the modified video asset, where the video/audio engine 121/215 may generate a subtitle file. The subtitle file may comprise the translated text of the subtitles in sequence, along with the corresponding timestamps.

At 514, the video/audio engine 121/215 may translate each turn of speech to the target language, where each turn of the translated speech may be associated with the corresponding timestamp. The video/audio engine 121/215 may, based on the identified actor(s) at 504, convert the translated text to speech of the target language. The video/audio engine 121/215 may generate a synthesized version of speech, using the speech model associated with the identified actor(s), as if the identified actor(s) speaking the target language. The video/audio engine 121/215 may input the translated text along with the extracted features (from the step 510). For example, the translated speech may match a particular emotion or intensity of the original speech, and the video/audio engine 121/215 may input the corresponding features (e.g., tone and cadence) associated with the emotion or intensity. The video/audio engine 121/215 may use the inputs of the translated text and the extracted features as well as the speech model to generate a melody (Mel) spectrogram. The Mel spectrogram may integrate linguistic information and acoustic characteristics derived from the extracted feature. The video/audio engine 121/215 may convert the feature-rich Mel spectrogram into an audio waveform, wherein the audio waveform can be heard as a speech. The video/audio engine 121/215 may synthesize the audio waveform, ensuring that the extracted features are reflected in the speech's acoustic properties.

At 516, the video/audio engine 121/215 may receive each turn of the speech translated to the target language from a third-party service or a content creator. The video/audio engine 121/215 may send, to the third-party service or the content creator, a request of translating the speech to the target language before receiving the translated speech. At 517, similar to step 508, the video/audio engine 121/215 may determine utterances of the translated speech from each actor, where the determined utterances may be associated with the timestamps. At 518, similar to step 510, features (e.g., tone, cadence, Mel-Frequency Cepstral Coefficients (MFCC), spectral contrast) of speech may be extracted by the video/audio engine 121/215. The method may proceed to step 522.

At 520, the video/audio engine 121/215 may generate a substitution actor with matching skin tone and size. The video/audio engine 121/215 may use the actor substitution data to determine a facial model associated with the replacement actor. The video/audio engine 121/215 may use the facial image model to generate facial images for the replacement actor. This may involve changing the actor's hair color, eye color, racial appearance, gender to better match the appearance of someone speaking the target language.

Step 522 may proceed after the steps 514/518 and/or 520 are completed. The video/audio engine 121/215 may obtain facial data and integrate with the translated speech. The video/audio engine 121/215 may access the facial image model from the actor model database. The video/audio engine 121/215 may, based on the facial image model and translated speech, generate facial data for each turn of the translated speech (from step 514/516). The video/audio engine 121/215 may determine phonemes from the translated speech, similar to step 510. Each turn of translated speech may be already timestamped, and it may not be necessary to determine utterances of the translated speech. The video/audio engine 121/215 may convert the translated speech in a phonetic script, where a phonetic script may list out all the phonemes spoken and the corresponding timestamps. Each phoneme corresponding to a specific mouth shape or position may be known as a viseme. The video/audio engine 121/215 may map the determined phonemes from the phonetic script to visemes. The video/audio engine 121/215 may use the facial image model from the actor model database to translate the visemes to mouth movements associated to the particular actor. The video/audio engine 121/215 may generate a new mouth movement if the mouth movement associated with the viseme is not predefined in the actor model database. The video/audio engine 121/215 may store the new mouth movement to the facial image model in the actor model database. The facial data are not limited to the mouth movements. For example, the facial data may comprise geometric features (e.g., distances and angles between key points on the face (e.g., eyes, nose, mouth, eyebrows, jawline)), texture information (e.g., skin texture, wrinkles, spots and other features providing detail beyond structure) and/or temporal information (e.g., changes in facial features over time). The video/audio engine 121/215 may input the extracted features (e.g., tone and cadence associated with an emotion or intensity extracted from the step 510/518) to generate additional facial data., where the facial data may match a particular emotion or intensity of the actor. For example, eyebrows may be drawn together and lowered if the actor is indicating an anger emotion. The video/audio engine 121/215 may, based on the position of actor obtained at 504, superimpose the facial data onto each frame of the original video asset. The video/audio engine 121/215 may replace the original audio with the translated speech from step 514/516 as if the actor in the modified video asset may appear speaking in the target language. At 520, the video/audio engine 121/215 may determine if the fragment is completely translated. For example, the video/audio engine 121/215 may repeat step 518 if there are additional turns of speech. The video/audio engine 121/215 may proceed to step 308 if the fragment is completely translated.

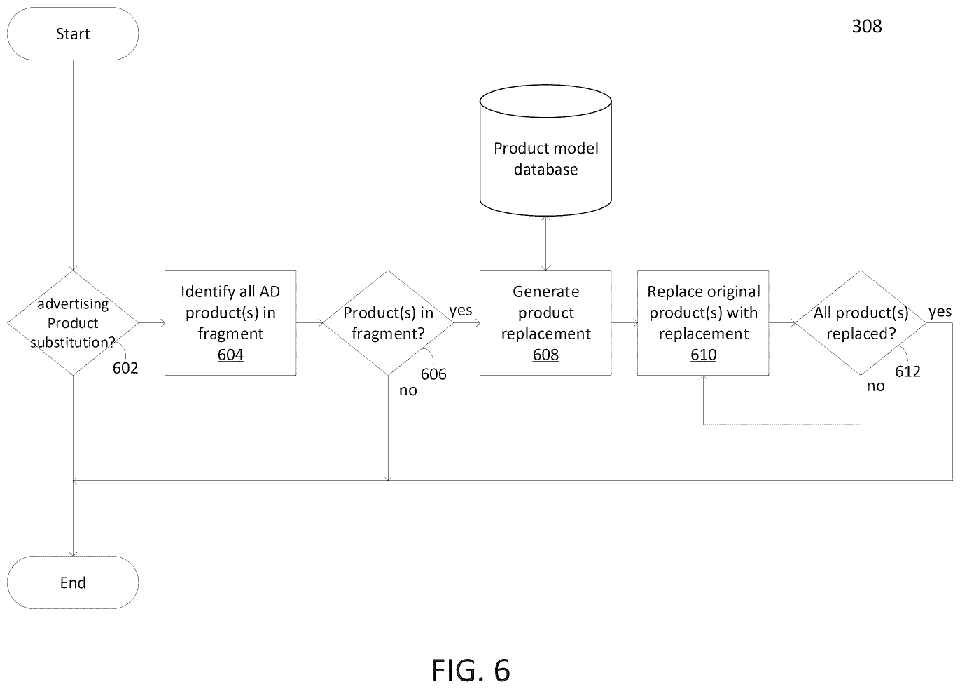

At 308, the video/audio engine 121/215 may substitute an advertising product from the loaded fragment. An advertising product may be changed based on regions. For example, the video fragment may show a cola soda as the original advertising product for US based video audience. A different advertising product (e.g., bubble tea) may be better resonating for Taiwanese based audience. FIG. 6 is a flowchart showing an example of step 308. The steps in FIG. 6 may be performed by any of the devices described herein, such as the video/audio engine 121/215.

At 602, the video/audio engine 121/215 may determine, based on the product placement substitution data (obtained in step 406), whether product placement substitution has been requested. A identification step may occur at 604 if there is product placement substitution. The step 308 may end if there is no product placement substitution.

At 604, the video/audio engine 121/215 may identify the advertising product to be substituted appearing in the one or more image frames. The video/audio engine 121/215 may generate region proposals (e.g., candidate bounding boxes) associated with the advertising product, where the region proposals may contain the edges of the advertising product. The region proposals may The video/audio engine 121/215 may further extract features from each region proposal using a deep convolutional neural network. The features may include height, length, color, texture, size, and so on. Relevant features may have a correlation associated to the product image model. The video/audio engine 121/215 may, based on the product image model, classify features as one of the known class, wherein the correlation may exceed a threshold. The product image model may be accessed from the product model database (e.g., product model database 123/218). The known class may be an object (e.g., the advertising product to be substituted). The video/audio engine 121/215 may determine, based on the classified features associated with the region proposal, the position of the advertising product. The position may be pixel indices and/or spatial coordinates (e.g., cartesian coordinates). At 606, the video/audio engine 121/215 may proceed to 608 if there is advertised product identified.

At 608, the video/audio engine 121/215 may generate a product replacement. The video/audio engine 121/215 may access the product image model from the product model database. The video/audio engine 121/215 may, based on the product placement substitution data, use the product model database to query a replacement product. The data associated with the original advertising product may comprise a name (e.g., cola) and the data associated with replacement advertising product may comprise a type of drink (e.g., cold drink) and country (e.g., Taiwan). A query result of the replacement product may be a bubble tea. The video/audio engine 121/215 may use the product image model to generate images for the replacement product. Using the example, images of bubble tea may be generated to replace the cola in the video.

At 610, the video/audio engine 121/215 may substitute the original advertising product with the replacement advertising product. For example, the video/audio engine 121/215 may superimpose, based on the position of the original advertising product, the replacement adverting product images onto the loaded fragment. The video/audio engine 121/215 may, based on the product placement substitution data, determine at 612 whether all original advertising products are substituted. The video/audio engine 121/215 may repeat step 610 if there are additional advertising product(s) to be substituted. Otherwise, the video/audio engine 121/215 may proceed to step 310.

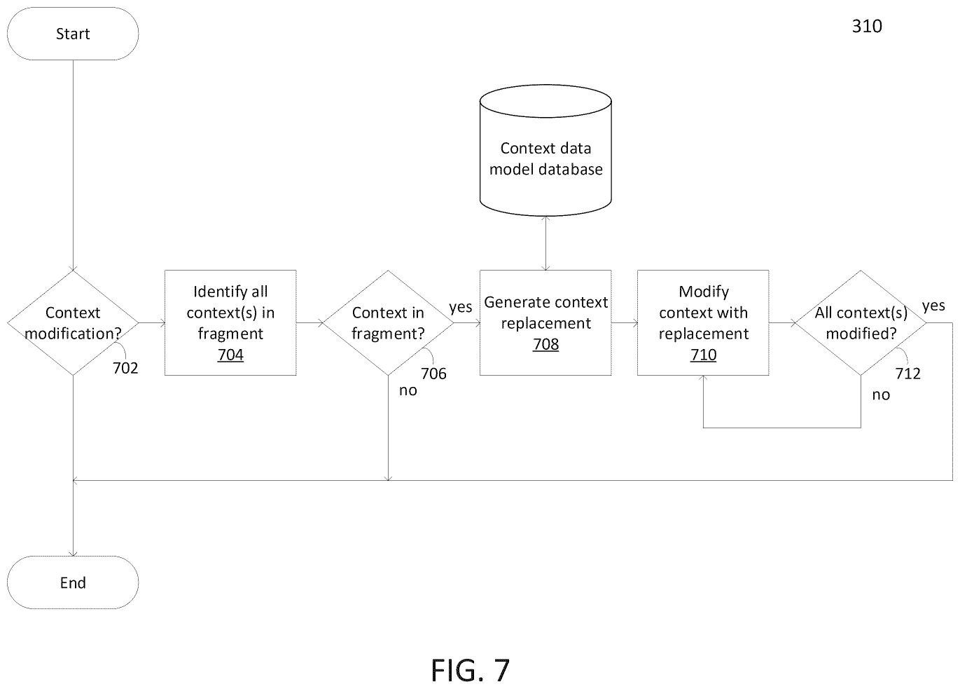

At 310, the video/audio engine 121/215 may modify context from the loaded fragment. The context may comprise components of the loaded fragment, such as mature themes, language (e.g., profanity, cultural expression), graphic violence, nudity, sensuality, depictions of sexual activity, adult activities, drug use, and/or background. The context may be added, removed and/or modified based on region or country. For example, the loaded fragment may comprise a cultural expression in a dialog (e.g., “that dog won't hunt”). The cultural expression may resonate in US and may not resonate in Malaysia. The background context may refer to the background scene. The original scene may include a background scene in New York City, and the background may be modified to Shanghai to be more suitable to Chinese audience. FIG. 7 is a flowchart showing an example of step 310. The steps in FIG. 7 may be performed by any of the devices described herein, such as the video/audio engine 121/215.

At 702, the video/audio engine 121/215 may determine, based on the context replacement data (obtained in step 408), whether there is context modification. The video/audio engine 121/215 may proceed to 704 if there is context modification. The step 310 may end if there is no context modification.

At 704, the video/audio engine 121/215 may identify the context to be substituted appear in the decomposed one or more images frames and audio frames at 304. The video/audio engine 121/215 may, based on the context replacement data, identify the context from one or more images frames and audio frames. For example, the context replacement data may instruct the video/audio engine 121/215 to identify video or audio associated with the context of graphic violence. The video/audio engine 121/215 may generate region proposals (e.g., candidate bounding boxes) associated with an image frame. The video/audio engine 121/215 may further extract features from each region proposal using a deep convolutional neural network. The features may include height, length, color, texture, size, and so on. Relevant features may have a correlation associated to the context model. The video/audio engine 121/215 may, based on the context model, classify features as one of the known class, wherein the correlation may exceed a threshold. The context model may be accessed from the context data model database (e.g., context data model database 124/219). The known class may be a context. For example, an image frame may comprise features of smearing blood and the image frame may be classified as the context of graphic violence. The video/audio engine 121/215 may determine, based on the classified features associated with the region proposal, the position of the context. The position may be pixel indices and/or spatial coordinates (e.g., cartesian coordinates). Similar to step 508 and 510, the video/audio engine 121/215 may extract utterances, determine the phonemes and convert the speech of the audio frames into text. The video/audio engine 121/215, based on the converted text, may identify the context. For example, the detected text from the audio frames may indicate “I lost my damn keys”, where the word “damn” may be identified as the context of profanity. For context associated with the audio frames, the video/audio engine 121/215 may identify the actor(s) similar to step 504. At 706, the video/audio engine 121/215 may proceed to 708 if there is context identified.

At 708, the video/audio engine 121/215 may generate a context replacement. The context replacement may depend on whether the context is image or audio based. The video/audio engine 121/215 may access the context model from the context data model database. The video/audio engine 121/215 may, based on the identified context, generate a context replacement. The video/audio engine 121/215 may use the context model to generate images or audio for context modification. Images associated with the identified context may be generated. For example, images of teddy bears may be generated to replace guns in a video. Similar to step 514, the video/audio engine 121/215 may generate a synthesized version of speech, using the speech model associated with the identified actor(s) at 704, as if the identified actor(s) speaking the modified dialog. For example, a new dialog of “I lost my darn keys” may be generated to replace the original dialog of “I lost my damn keys”.

At 710, the video/audio engine 121/215 may modify context with replacement. For image-based context, the video/audio engine 121/215 may perform a similar step in 610 to replace the images associated with the identified context. For audio-based context, the video/audio engine 121/215 may perform a similar step in 522 to replace the dialog associated with the identified context. The video/audio engine 121/215 may determine at 712 whether all identified contexts are modified. The video/audio engine 121/215 may repeat step 710 if there are additional contexts to be modified. Otherwise, the video/audio engine 121/215 may proceed to step 312.

At 312, the video/audio engine 121/215 may update a manifest file to reflect changes of the substituted actor and replaced language (step 306), replaced advertising product (step 308) and the modified context (step 310). An example of manifest file is shown in FIG. 8. The manifest file 800 may comprise sections, such as title 802, length 804, file type 806, creation date 808, storage location 810, public key 812, language 814, context 816, country 818, advertising product 820, actor 822, access right 824, etc. For example, the video/audio engine 121/215 may update language 814 to reflect the change of the target language.

The title 802 may indicate the title of the video asset. The length 804 may indicate the length of the video asset with a time unit (e.g., nanosecond). The file type 806 may indicate a file format of the video object (e.g., MP4, MOV, AVI, WMV, AVCHD, WebM, HTML5, FLV, MKV, MPEG-2, etc.) The creation date 808 may indicate a date which the video asset is generated. The storage location 810 may indicate where the video asset is currently stored. The video asset may be currently stored at a local office (e.g., local office 103) or a location different from the local office (e.g., a cloud storage, a file server, server farm, etc.). The public key 812 may be used to decrypt the video asset if the video object is encrypted. The language 814 may indicate the language of the video asset (e.g., English, Spanish, French, Italian, German, Japanese, Chinese, etc.). The context 816 may indicate an environment and setting associated with the video asset, such as mature themes, language (e.g., profanity, cultural expression), graphic violence, nudity, sensuality, depictions of sexual activity, adult activities, drug use, background, etc. The country 818 may indicate one or more countries or regions of the target audience. The advertising product 820 may indicate one or more advertising products appearing in the video asset. The actor 822 may indicate one or more actors appearing in the video asset. The access right 824 may indicate at least one of user name, country, region and/or country, where users associated with the user name, country, region and/or country have the access right to the video asset.

At 314, the video/audio engine 121/215 may determine if there is additional fragment(s) of video asset. The video/audio engine 121/215 may repeat 304 if there is additional fragment(s). The video/audio engine 121/215 may publish the video asset at 316. The video/audio engine 121/215 may encode the video asset for a smaller size so that the video asset may be sent or streamed to users more efficiently. The video/audio engine 121/215 may integrate the subtitles (e.g., subtitle file) generated in step 512 into the video asset. The video/audio engine 121/215 may be embedded the subtitle file in the same storage folder of the video asset, and users may turn on the subtitle feature on-demand. The video/audio engine 121/215 may permanently embedded the subtitles into the video asset by encoding the video asset with subtitle text from the subtitle file.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A method comprising:
receiving a request for a target language associated with a video asset, wherein:
the video asset comprises at least one first dialog in a native language; and
the target language is different from the native language;
determining at least one phoneme associated with at least one second dialog in the target language;
converting, based on the at least one phoneme, the at least one second dialog in a script;
generating, based on the script and a model database, facial data associated with an actor in the at least one second dialog; and
integrating the facial data and the at least one second dialog into the video asset.

2. The method of claim 1, further comprising:
receiving a request for an updated context associated with the video asset, wherein:
the video asset comprises at least one third dialog in an original context; and
the updated context is different from the original context;
determining at least one second phoneme associated with at least one fourth dialog in the updated context;
converting, based on the at least one second phoneme, the at least one fourth dialog in a second script;
generating, based on the second script and the model database, second facial data associated with an actor in the at least one fourth dialog; and
integrating the second facial data and the at least one fourth dialog into the video asset.

3. The method of claim 1, further comprising:
receiving a request for a target actor associated with the video asset, wherein:
the video asset comprises at least one fifth dialog associated with an original actor; and
the target actor is different from the original actor;
determining at least one third phoneme associated with at least one sixth dialog associated with the target actor;
converting, based on the at least one third phoneme, the at least one sixth dialog in a third script;
generating, based on the third script and the model database, third facial data associated with the target actor in the at least one sixth dialog; and
integrating the third facial data and the at least one sixth dialog into the video asset.

4. The method of claim 1, wherein the generating the facial data further comprises:
mapping the determined at least one phoneme to at least one viseme, wherein the determined at least one phoneme is associated with the script; and
translating, based on a facial image model, the at least one viseme to at least one mouth movement associated to the actor.

5. The method of claim 1, wherein the generating the facial data further comprises:
mapping the determined at least one phoneme to at least one viseme, wherein the determined at least one phoneme is associated with the script;
generating at least one mouth movement, wherein the at least one mouth movement associated with the at least one viseme is not defined in a facial image model; and
storing the at least one mouth movement in the facial image model.

6. The method of claim 1, wherein the integrating the facial data and the at least one second dialog further comprises:
replacing the at least one first dialog with the at least one second dialog; and
superimposing the facial data onto at least one frame of the video asset.

7. The method of claim 1, wherein the script lists the at least one phoneme and at least one corresponding timestamp.

8. The method of claim 1, wherein the facial data comprises at least one of:
mouth movements;
geometric features;
texture information; or
temporal information.

9. A method comprising:
receiving a request for an updated context associated with a video asset, wherein:
the video asset comprises at least one first dialog in an original context; and
the updated context is different from the original context;
determining at least one phoneme associated with at least one second dialog in the updated context;
converting, based on the at least one phoneme, the at least one second dialog in a script;
generating, based on the script and a model database, facial data associated with an actor in the at least one second dialog; and
integrating the facial data and the at least one second dialog into the video asset.

10. The method of claim 9, further comprising:
identifying the original context in the at least one first dialog, wherein the original context indicates at least one of:
profanity;
violence;
cultural expression; or
adult activity.

11. The method of claim 10, wherein the identifying the at least one first dialog in the original context further comprises:
converting the at least one first dialog into text; and
identifying, based on the converted text, the original context.

12. The method of claim 9, further comprising:
identifying, based on an image model, the actor in the at least one first dialog; and
generating, based on a speech model associated with the actor, the at least one second dialog.

13. The method of claim 9, wherein the integrating the facial data and the at least one second dialog further comprises:
replacing the at least one first dialog with the at least one second dialog; and
superimposing the facial data onto at least one frame of the video asset.

14. The method of claim 9, further comprising:
verifying, with a digital right server, a license agreement for manipulating the facial data associated with the actor.

15. A method comprising:
receiving a request for a target actor associated with a video asset, wherein:
the video asset comprises at least one first dialog associated with an original actor; and
the target actor is different from the original actor;
determining at least one phoneme associated with at least one second dialog associated with the target actor;
converting, based on the at least one phoneme, the at least one second dialog in a script;
generating, based on the script and a model database, facial data associated with the target actor in the at least one second dialog; and
integrating the facial data and the at least one second dialog into the video asset.

16. The method of claim 15, further comprising:
receiving at least one parameter associated with the target actor;
determining, based on the at least one parameter, a facial model associated with the replacement actor; and
generating, based on the facial model, at least one actor image associated with the target actor, wherein the at least one actor image comprises the facial data.

17. The method of claim 16, wherein the receiving at least one parameter associated with the target actor further comprises:
receiving, based on a region of a viewer of the video asset, the at least one parameter, wherein the region of the viewer is different from a region associated with the video asset.

18. The method of claim 15, further comprising:
identifying the original actor associated with the video asset, wherein the identifying the original actor further comprises:
generating at least one region proposal associated with the original actor;
extracting, based on the at least one region proposal, at least one feature; and
classifying, based on the at least one feature, the original actor.

19. The method of claim 15, further comprising:
updating a manifest file with an identifier of the target actor.

20. The method of claim 15, wherein the integrating the facial data and the at least one second dialog further comprises:
replacing the at least one first dialog with the at least one second dialog; and
superimposing the facial data onto at least one frame of the video asset.
